(19) United States
(12) Patent Application Publication
(10) Pub. No.: US 2026/0227240 A1
(43) Pub. Date: Aug. 6, 2026

(54) INFRARED IMAGING DEVICE

(71) Applicant: Mitsubishi Electric Corporation, Tokyo (JP)

(72) Inventors: Ryo MIURA, Tokyo (JP); Tomohiro MAEGAWA, Tokyo (JP); Shinichi YASUI, Tokyo (JP); Kanta MATSUSHITA, Tokyo (JP)

(73) Assignee: Mitsubishi Electric Corporation, Tokyo (JP)

(21) Appl. No.: 19/149,535

(22) PCT Filed: May 26, 2023
(86) PCT No.: PCT/JP2023/019747

§ 371 Date: Jul. 18, 2025

(51) Int. Cl. G01J 5/0806; G01J 5/00

(52) U.S. Cl. CPC G01J 5/0806; G01J 2005/0077

(57) ABSTRACT

A treated surface (12) for reducing transmittance of near-infrared radiation having a wavelength of 6 μm or less is formed on an optical member (1,4). A detection pixel (3) receives infrared radiation transmitted through the optical member (1,4) and converts the infrared radiation into an electrical signal.

### FIELD

The present disclosure relates to an infrared imaging device.

### BACKGROUND

An infrared imaging device that measures temperature by detecting infrared radiation emitted from an object is used. Far-infrared energy is large when the object is at room temperature, and near-infrared energy is large when the object is at a high temperature.

Focusing on this aspect, an infrared imaging device has been proposed that measures temperature highly accurately by preparing a spectral filter that selectively passes various wavelengths and a detector that has a sensitivity peak in the far-infrared range (see, for example, PTL 1).

### CITATION LIST

### Patent Literature

[PTL 1]

### SUMMARY OF THE INVENTION

### Problem to be Solved by the Invention

Near-infrared radiation is easily affected by the atmosphere, and, therefore, when the temperature of a high-temperature object is measured using near-infrared radiation, the measured temperature largely varies depending on factors such as a change in the distance to the object. Moreover, since the near-infrared radiation increases as the temperature of the object increases, the amount of light incident on a detection unit increases nonlinearly. Consequently, the detection accuracy decreases sharply when imaging a high-temperature object. If an optical filter that limits the incidence of near-infrared radiation is inserted to solve such a problem, the number of components will increase.

The present disclosure has been made to solve the problem mentioned above, and the purpose of the disclosure is to provide an infrared imaging device capable of improving the detection accuracy without increasing the number of components.

### Solution to Problem

An infrared imaging device according to the present disclosure includes: an optical member on which a treated surface for reducing transmittance of near-infrared radiation having a wavelength of 6 um or less is formed; and a detection pixel receiving infrared radiation transmitted through the optical member and converting the infrared radiation into an electrical signal.

### Advantageous Effects of Invention

In the present disclosure, the treated surface for reducing the transmittance of near-infrared radiation having a wavelength of 6 μm or less is formed on the optical member. This makes it possible to reduce the transmittance of near-infrared radiation without increasing the number of components. Since this causes far-infrared radiation to be selectively transmitted, it is possible to reduce the nonlinear change in the amount of infrared radiation incident on the detection unit due to a change in the object's temperature. Consequently, since the resolution of the AD converter when imaging a high-temperature object is improved, the absolute temperature detection accuracy of the infrared sensor is improved.

### BRIEF DESCRIPTION OF THE DRAWINGS

FIG. 1 is a diagram showing an infrared imaging device according to Embodiment 1.

FIG. 2 is an enlarged cross-sectional view of the lid wafer and the infrared sensor.

FIG. 3 is a diagram showing Planck's radiation law.

FIG. 4 is a diagram showing the relative incident light amount to the object's temperature.

FIG. 5 is a diagram showing an infrared imaging device according to Embodiment 2.

FIG. 6 is a diagram showing an infrared imaging device according to Embodiment 3.

FIG. 7 is a diagram showing an infrared imaging device according to Embodiment 4.

### DESCRIPTION OF EMBODIMENTS

An infrared imaging device according to the embodiments of the present disclosure will be described with reference to the drawings. The same components will be denoted by the same symbols, and the repeated description thereof may be omitted.

### Embodiment 1

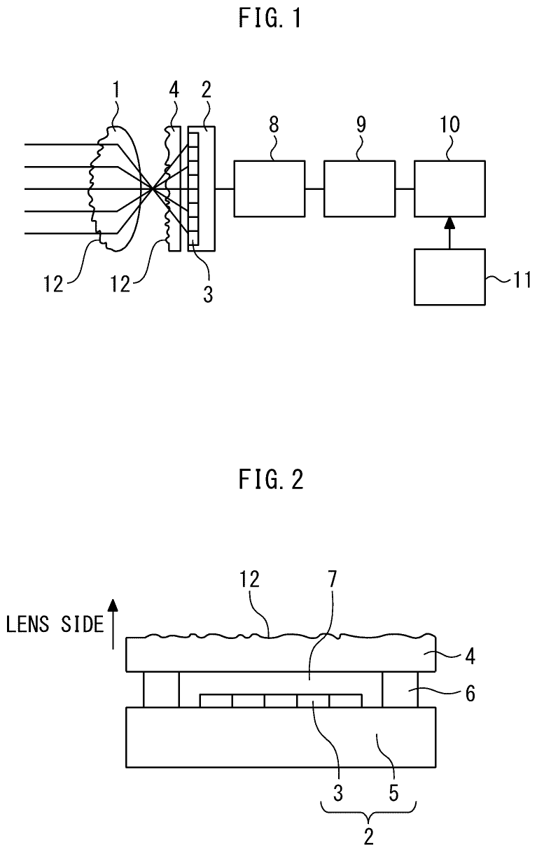

FIG. 1 is a diagram showing an infrared imaging device according to Embodiment 1. An infrared sensor 2 detects infrared radiation transmitted through an infrared-transmitting lens 1. A plurality of detection pixels 3 for converting received infrared radiation into an electrical signal are disposed in a two-dimensional array on a light-receiving surface of the infrared sensor 2. The infrared-transmitting lens 1 focuses infrared radiation onto the detection pixels 3. The detection pixels 3 detect both near-infrared radiation and far-infrared radiation as the sensitivity peak is not particularly limited.

The detection pixels 3 are constituted by diodes. When the detection pixels 3 receive infrared radiation, the detection pixels 3 generate heat, and the electric current in the diodes decreases. The amount of infrared radiation is detected by the decrease in the electric current value. Therefore, if the detection pixels 3 dissipate heat, infrared radiation cannot be detected. In order to prevent heat dissipation of the detection pixels 3, the periphery of the detection pixels 3 is vacuum-sealed by covering the detection pixels 3 with a lid wafer 4 such that the lid wafer 4 is not in contact with the detection pixels 3.

FIG. 2 is an enlarged cross-sectional view of the lid wafer and the infrared sensor. A sensor wafer 5 is made of, for example, silicon. The detection pixels 3 are formed on the sensor wafer 5. The detection pixels 3 and the sensor wafer 5 are collectively referred to as the infrared sensor 2. The lid wafer 4 is joined to the sensor wafer 5 by a vacuum-sealing seal 6. The vacuum-sealing seal 6 is made of, for example, Ni, Au or SnAgCu. By this bonding, a hollow section 7 between the surface of the sensor wafer 5 on which the detection pixels 3 are formed and the lid wafer 4 is brought into a vacuum state.

A signal processing unit 8 has an AD converter that converts an output from the infrared sensor 2 into a digital signal. The resolution of the AD converter is limited. Note that the resolution of the AD converter means the level of detail of a change in the amount of infrared radiation that can be seen with one bit, and is obtained by dividing the amount of incident infrared radiation at a certain temperature by the number of bits of the AD converter. Therefore, the resolution is improved by decreasing the amount of incident infrared radiation.

An optical property modification unit 9 modifies an output from the signal processing unit 8. A temperature measurement unit 10 calculates the temperature of an object by dividing an output voltage of the optical property modification unit 9 by a reference voltage output from a reference temperature detection unit 11.

In the infrared sensor 2 using a light-focusing optical system, the central part of a detection area has the highest sensitivity, and a so-called vignetting phenomenon in which the sensitivity decreases toward the outer periphery of the detection area is seen. Then, the optical property modification unit 9 reduces vignetting by multiplying output data from the outer periphery of the detection area by a certain magnification ratio. This makes it possible to achieve a uniform sensitivity over the entire surface.

In the present embodiment, a treated surface 12 is formed on a light-receiving surface of at least one of the optical members, namely the infrared-transmitting lens 1 and the lid wafer 4.

The treated surface 12 is periodic surface irregularities with a size of about 6 μm, or a randomly rough surface. Infrared radiation with a wavelength equal to or less than the height and spacing of the irregularities of the treated surface 12 is affected by the treated surface 12, is diffusely reflected on the surface and inside of the optical member, and is absorbed by the optical member. Therefore, the treated surface 12 reduces the transmittance of near-infrared radiation having a wavelength of 6 um or less. This makes it possible to selectively transmit far-infrared radiation having a wavelength longer than 6 μm. Note that, if the treated surface 12 is a randomly rough surface instead of patterned irregularities, moire can also be prevented. Furthermore, each of the light-receiving surface of the infrared-transmitting lens 1 and the light-receiving surface of the lid wafer 4 is a surface on the opposite side from a surface facing the detection pixels 3.

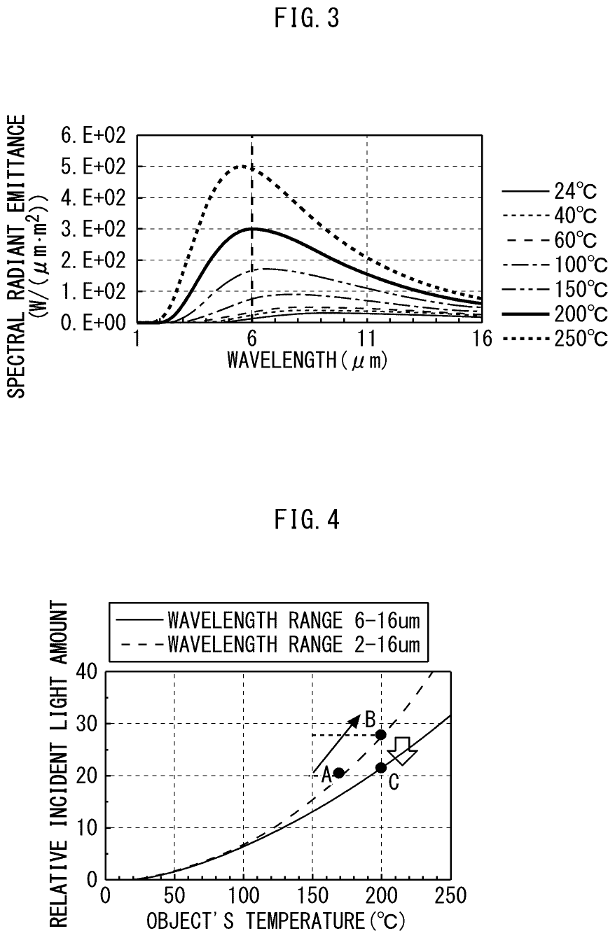

FIG. 3 is a diagram showing Planck's radiation law. The area enclosed by the graph of Planck's radiation law corresponds to the amount of infrared radiation. Although far-infrared radiation is dominant up to 100° C., near-infrared radiation is dominant at higher temperatures.

Regarding near-infrared radiation having a wavelength of 6 μm or less, the change in area increases as the temperature increases. Therefore, as the temperature increases, the amount of infrared radiation changes nonlinearly due to the influence of near-infrared radiation. When the amount of infrared radiation changes nonlinearly, the amount of infrared radiation increases, and the AD converter needs to detect a larger electrical signal, resulting in a decrease in detection accuracy.

FIG. 4 is a diagram showing the relative incident light amount to the object's temperature. The relative incident light amount is 1 when the environmental temperature is 24° C. and the object's temperature is 40° C. When infrared radiation (wavelength range: 2-16 μm) including both near-infrared radiation and far-infrared radiation is incident, if the temperature rises from the A point to the B point, the relative incident light amount increases rapidly, and, consequently, the detection accuracy rapidly decreases. On the other hand, when only far-infrared radiation (wavelength range: 6-16 μm) is incident, since the relative incident light amount decreases to the C point at the same object's temperature as the B point, the detection accuracy is improved.

As described above, in the present embodiment, the treated surface 12 for reducing the transmittance of near-infrared radiation having a wavelength of 6 μm or less is formed on the optical member. This makes it possible to reduce the transmittance of near-infrared radiation without increasing the number of components. Since this causes far-infrared radiation to be selectively transmitted, it is possible to reduce the nonlinear change in the amount of infrared radiation incident on the detection pixels 3 due to a change in the object's temperature. Consequently, since the resolution of the AD converter when imaging a high-temperature object is improved, the absolute temperature detection accuracy of the infrared sensor 2 is improved.

Moreover, since the change in the amount of infrared radiation is approximated linearly, the scale of a modification arithmetic operation in calculating the absolute temperature can be reduced.

More specifically, when the treated surface 12 reduces the transmittance of near-infrared radiation by 30% or more, the resolution of the AD converter is improved. Note that the treated surface 12 preferably reduces the transmittance of near-infrared radiation by 50% or more.

Furthermore, whether the resolution of the AD converter is sufficient or not depends on the level of detection accuracy that a user requires for a final sensor module.

### Embodiment 2

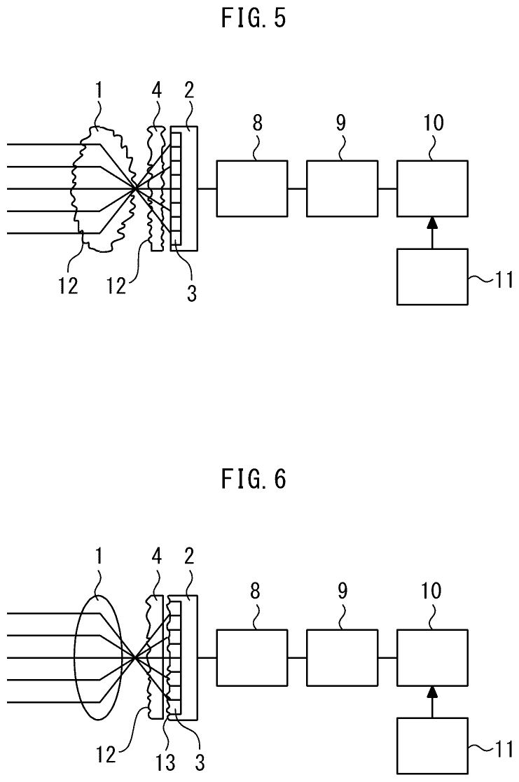

FIG. 5 is a diagram showing an infrared imaging device according to Embodiment 2. The treated surface 12 is formed not only on the light-receiving surfaces of the infrared-transmitting lens 1 and the lid wafer 4, but also on light-emitting surfaces of the infrared-transmitting lens 1 and the lid wafer 4 that face the detection pixels 3. Other configurations are the same as in Embodiment 1. In this case, the same effects as those in Embodiment 1 can also be obtained.

### Embodiment 3

FIG. 6 is a diagram showing an infrared imaging device according to Embodiment 3.

The treated surface 12 is formed on the light-receiving surface of the lid wafer 4. A rough surface 13 for preventing reflection of far-infrared radiation with wavelengths of 6 to 14 μm is formed on the light-receiving surfaces of the detection pixels 3. Other configurations are the same as in Embodiment 1. The rough surface 13 can prevent reflection of far-infrared radiation with wavelengths of 6 to 14 μm by absorbing the radiation by diffusion, scattering, and multiple reflections. In addition, the same effects as those in Embodiment 1 can be obtained.

### Embodiment 4

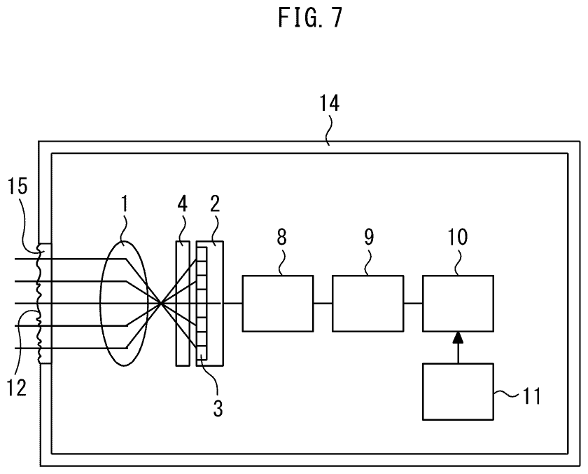

FIG. 7 is a diagram showing an infrared imaging device according to Embodiment 4. A case 14 encloses the infrared-transmitting lens 1, the infrared sensor 2, the lid wafer 4, the signal processing unit 8, the optical property modification unit 9, the temperature measurement unit 10, and the reference temperature detection unit 11. A window through which infrared radiation is incident is formed in the case 14. The window is provided with a lens protection plate 15 that protects the infrared-transmitting lens 1 from impact and dirt during actual use. The material of the lens protection plate 15 is, for example, high-density polyethylene (HDPE), Si, or chalcogenide. Infrared radiation transmitted through the lens protection plate 15 is incident on the infrared-transmitting lens 1. The treated surface 12 for reducing the transmittance of near-infrared radiation having a wavelength of 6 μm or less is formed on a light-receiving surface of the lens protection plate 15. Consequently, the same effects as those in Embodiment 1 can be obtained.

### REFERENCE SIGNS LIST

1 infrared-transmitting lens (optical member); 3 detection pixel; 4 lid wafer (optical member); 12 treated surface; 13 rough surface; 15 lens protection plate (optical member)

1. An infrared imaging device comprising:
an optical member on which a treated surface for reducing transmittance of near-infrared radiation having a wavelength of 6 μm or less is formed; and
a detection pixel receiving infrared radiation transmitted through the optical member and converting the infrared radiation into an electrical signal.

2. The infrared imaging device according to claim 1, wherein the optical member is an infrared-transmitting lens focusing the infrared radiation onto the detection pixel.

3. The infrared imaging device according to claim 1, wherein the optical member is a lid wafer vacuum-sealing the detection pixel.

4. The infrared imaging device according to claim 1, further comprising an infrared-transmitting lens focusing the infrared radiation onto the detection pixel,
wherein the optical member is a lens protection plate protecting the infrared-transmitting lens.

5. The infrared imaging device according to claim 1, wherein the treated surface is formed on a light-receiving surface of the optical member that is a surface on an opposite side from a surface facing the detection pixel.

6. The infrared imaging device according to claim 1, wherein a rough surface for preventing reflection of far-infrared radiation with wavelengths of 6 to 14 μm is formed on a light-receiving surface of the detection pixel.

7. The infrared imaging device according to claim 1, wherein the treated surface reduces transmittance of the near-infrared radiation by 30% or more.

8. The infrared imaging device according to claim 1, wherein the treated surface reduces transmittance of the near-infrared radiation by 50% or more.

9. The infrared imaging device according to claim 1, wherein the treated surface is periodic surface irregularities.

10. The infrared imaging device according to claim 1, wherein the treated surface is a randomly rough surface.
